(19) United States
(12) Patent Application Publication
(10) Pub. No.: US 2014/0120781 A1
(43) Pub. Date: May 1, 2014

(54) MICRO-CONNECTOR SOCKET

(71) Applicant: ADVANCED-CONNECTEK INC., Taipei (TW)

(72) Inventors: FEI-WU DONG, Taipei (TW); WEI WAN, Taipei (TW); SHU-LIN DUAN, Taipei (TW); Ching-Tien CHEN, Taipei (TW)

(73) Assignee: ADVANCED-CONNECTEK INC., Taipei (TW)

(21) Appl. No.: 14/063,538

(22) Filed: Oct. 25, 2013

(30) Foreign Application Priority Data
Oct. 26, 2012 (CN) 201210414309.6
Oct. 26, 2012 (CN) 201220552663.0

(51) Int. Cl. H01R 13/04

(52) U.S. Cl. CPC H01R 13/04
USPC 439/660

(57) ABSTRACT

A micro-connector socket which is capable of being connected with a predefined connector plug includes an insulating main body, a plurality of terminals and a metal housing. The insulating main body includes a base portion, a positioning portion and a tongue plate. The positioning portion is formed by extending the base portion backwardly, and the tongue plate is formed by extending the base portion forwardly and has a terminal groove passing through the base portion and the positioning portion. The terminals are inserted into the terminal groove of the insulating main body. The metal housing encloses out of the insulating main body. The terminals are positioned by the positioning portion, so that the terminals are in their corresponding true positions.

### CROSS-REFERENCES TO RELATED APPLICATIONS

This non-provisional application claims priority under 35 U.S.C. §119(a) on Patent Application No. 201210414309.6 and 201220552663.0, both filed in China, P.R.C. on 2012 Oct. 26, the entire contents of which are hereby incorporated by reference.

### BACKGROUND

1. Technical Field

The disclosure relates to a connector socket, and particularly to a micro-connector socket in which the insulating main body of the micro-connector socket includes a positioning portion capable of positioning the terminals of the micro-connector socket in their corresponding true positions, thereby the micro-connector socket stabilizing the transmitting signals of the electronic device and meeting the requirements of the electronic characteristics.

2. Related Art

As technology continues to develop, various electronic devices are invented regularly. In order to transmit the signals of electronic devices, connector sockets are also necessary.

Displayport is a digital display interface developed by Video Electronics Standards Association, applied to connect computers with monitors or home theater systems and capable of replacing the conventional analog transmitting interfaces (namely, VGA), and the conventional digital transmitting interfaces (that is, DVI). Additionally, some companies publish mini-sized Displayports called Mini Displayports, which can support VGA and DVI interfaces with adapters, and are mainly applied to Mac notebooks.

Please refer to FIG. 1, which is an exploded view of a conventional connector socket 10. As shown in FIG. 1, the conventional connector socket 10 can be connected with a connector plug (not shown). The conventional connector socket 10 is applicable to the Mini Displayport interface and includes an insulating main body 11, a plurality of terminals 16, a metal housing 17 and a rear stopper 15. The insulating main body 11 substantially consists of a first main body 12 and a second main body 13, and includes a terminal groove 14. The terminals 16 are inserted into the terminal groove 14 of the insulating main body 11. The metal housing 17 encloses out of the insulating main body 11. The rear stopper 15 is assembled with the insulating main body 1 with a plurality of voids 151 opened for passing the terminals 16.

Upon assembly, the terminals 16 of the conventional connector socket 10 are assembled in the terminal groove 14 of the insulating main body 11; the voids of the rear stopper 15 are then provided to receive the terminals 16 and fasten the positions of the terminals 16; in this way, the metal housing 17 encloses out of the insulating main body 11; as a result, the assembling of the conventional connector socket 10 is achieved.

However, although the voids 151 can fasten the positions of the terminals 16 to ensure the terminals 16 match the connecting regions on the circuit board, the transmitting signals are unstable, due to the gaps existed between the voids 151 and the terminals 16.

### SUMMARY

In view of this, the disclosure provides micro-connector socket including an insulating main body, a plurality of terminals and a metal housing. The insulating main body includes a base portion, a positioning portion and a tongue plate. The positioning portion is formed by extending the base portion backwardly, and the tongue plate is formed by extending the base portion forwardly and has a terminal groove passing through the base portion and the positioning portion. The terminals are inserted into the terminal groove of the insulating main body. The metal housing encloses out of the insulating main body. The terminals are positioned by the positioning portion, so that the terminals are in their corresponding true positions.

In one preferred implementation aspect, the insulating main body includes a main body connected with the base portion, such that the main body and the base are formed integrally as a whole or detachably assembled with each other.

In one preferred implementation aspect, the terminals include an upper terminal and a lower terminal.

In one preferred implementation aspect, the upper terminal includes a first upper bending portion and a second upper bending portion.

In one preferred implementation aspect, the upper terminal further includes a third upper bending portion and a fourth upper bending portion.

In one preferred implementation aspect, the lower terminal includes a first lower bending portion.

In one preferred implementation aspect, the lower terminal further includes a second lower bending portion and a third lower bending portion.

In one preferred implementation aspect, the lower terminal includes a first lower terminal and a second lower terminal.

In one preferred implementation aspect, the lower terminal further includes a third lower terminal.

In one preferred implementation aspect, the micro-connector socket is applicable with the Mini Displayport interface.

As mentioned above, due to the positioning portion being formed by extending the base portion of the insulating main body backwardly, and the base portion having the terminal groove defined through the positioning portion, the terminals are positioned by the positioning portion, so that the terminals are in true positions, thereby stabilizing the transmitting signals of an electronic device with the micro-connector socket and meeting the requirements of the electronic characteristics.

The detailed features and advantages of the disclosure are described below in great detail through the following embodiments; the content of the detailed description is sufficient for those skilled in the art to understand the technical content of the disclosure and to implement the disclosure there accordingly. Based on the content of the specification, the claims, and the drawings, those skilled in the art can easily understand the relevant objectives and advantages of the disclosure.

### BRIEF DESCRIPTION OF THE DRAWINGS

The disclosure will become more fully understood from the detailed description given herein below for illustration only and thus not limitative of the disclosure, wherein:

FIG. 1 is an exploded view of a conventional connector socket;

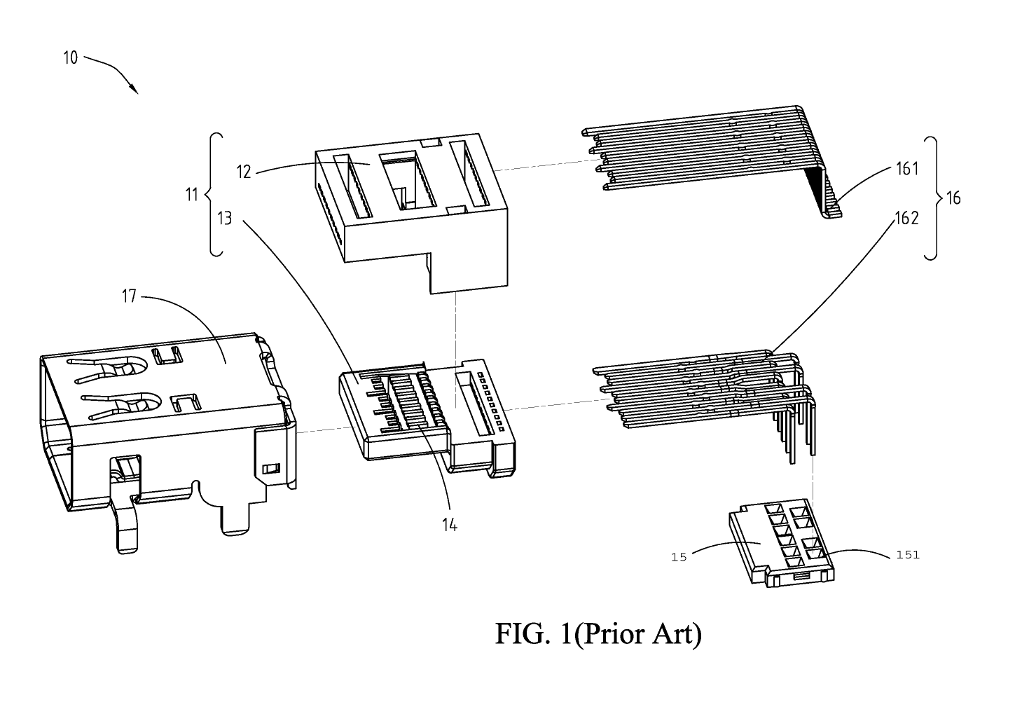

FIG. 2 is a perspective view of some components of a micro-connector socket of a first embodiment of the disclosure;

FIG. 3 is an exploded view of the micro-connector socket of the first embodiment of the disclosure;

FIG. 4 is a perspective view of some components of a micro-connector socket of a second embodiment of the disclosure;

FIG. 5 is an exploded view of the micro-connector socket of the second embodiment of the disclosure;

FIG. 6 is a perspective view of some components of a micro-connector socket of a third embodiment of the disclosure;

FIG. 7 is an exploded view of the micro-connector socket of the third embodiment of the disclosure;

FIG. 8 is a perspective view of some components of a micro-connector socket of a fourth embodiment of the disclosure; and

FIG. 9 is an exploded view of the micro-connector socket of the fourth embodiment of the disclosure.

### DETAILED DESCRIPTION

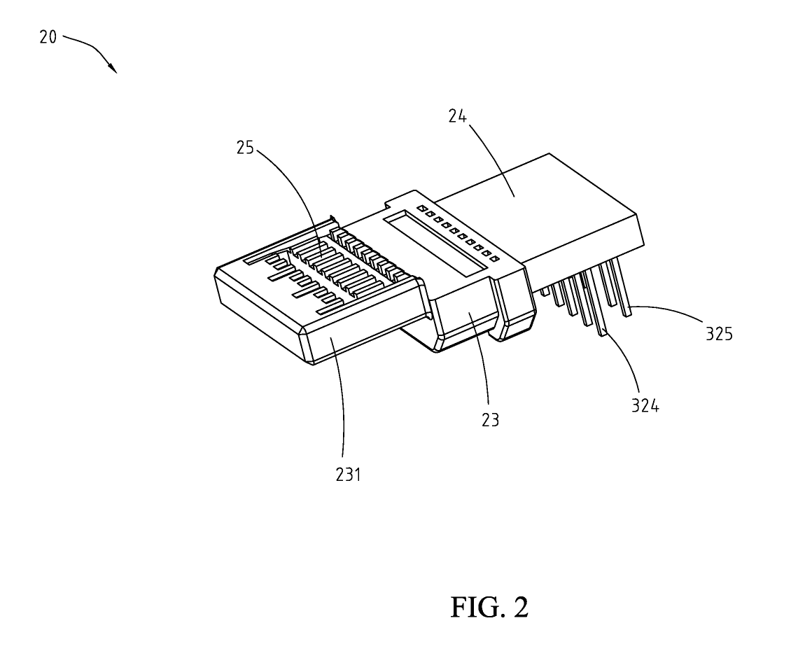

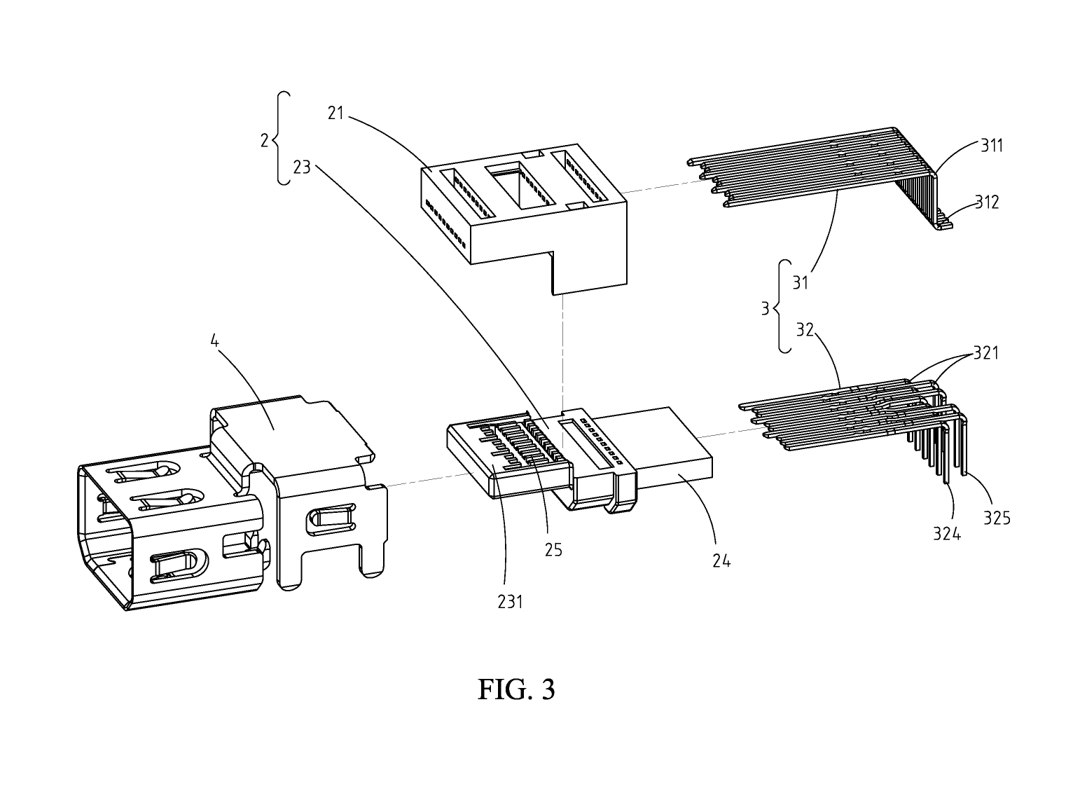

Please refer to FIG. 2 and FIG. 3, which are a perspective view of some components of a micro-connector socket 20 of a first embodiment of the disclosure and an exploded view of the micro-connector socket 20 of the first embodiment of the disclosure respectively. As shown in FIG. 2 and FIG. 3, the micro-connector socket 20 can be connected with a predefined connector plug (not shown). The micro-connector socket 20 can be applicable with the Mini Displayport interface and includes an insulating main body 2, a plurality of terminals 3 and a metal housing 4.

The insulating main body 2 includes a base portion 23, a tongue plate 231 and a positioning portion 24 in which the tongue plate 231 is formed by extending the base portion 23 forwardly and the positioning portion 24 is formed by extending the base portion 23 backwardly. The tongue plate 231 has a terminal groove 25 passing through the base portion 23 and the positioning portion 24.

The terminals 3 are inserted into the terminal groove 25 of the insulating main body 2. In this embodiment, the terminals 3 include an upper terminal 31 and a lower terminal 32. The upper terminal 31 includes a first upper bending portion 311 and a second upper bending portion 312. The lower terminal 32 includes a first lower bending terminal 321. The lower terminal 32 also includes a first lower terminal 324 and a second lower terminal 325 to form a two-series terminal structure. Preferably, the upper terminal 31 and the lower terminal 32 can be welded using DIP (dual in-line package), or SMT (surface mount technology), methods.

The metal housing 4 encloses out of the insulating main body 2 for shielding.

It is to be understood that in the first embodiment, the insulating main body 2 includes a main body 21 and the base portion 23. Preferably, the insulating main body 2 can be one-pieced (not shown), that is, the main body 21 and the base 23 are formed integrally as a whole; conversely, the main body 21 and the base 23 can be detachably assembled with each other. Additionally, in the first embodiment the upper terminal 31 has the first upper bending portion 311 and the second upper bending portion 312, and the lower terminal 32 has the first lower bending terminal 321, so that the micro-connector socket 20 can match and connect with the circuit board; that is, the number of the bending portion is not limited by the disclosure.

Upon assembly, the upper terminal 31 and the lower terminal 32 are preferably assembled in the terminal groove 25 of the insulating main body 2 via an embedded manufacturing process, and the metal housing 4 is provided to enclose out of the insulating main body 2, thereby completing the assembling of the micro-connector socket 20. Due to the positioning portion 24 being formed by extending the base portion 23 of the insulating main body 2 backwardly, and the base portion 23 having the terminal groove 25 which is defined through the positioning portion 24, the terminals 3 are positioned by the positioning portion 24, so that the terminals 3 are in true positions, thereby stabilizing the transmitting signals of an electronic device with the micro-connector socket 20 and meeting the requirements of the electronic characteristics.

Additionally, the rear stopper 15 applied in the conventional connector socket 10 is not applied in the disclosure, thereby reducing both the difficulty of the manufacturing processes, and the manufacturing costs.

Furthermore, the modularized design of the disclosure aids the community between different electronic devices. In addition, the manufacturer can develop the customized micro-connector sockets 20 according to customer requirements, with minimal costs.

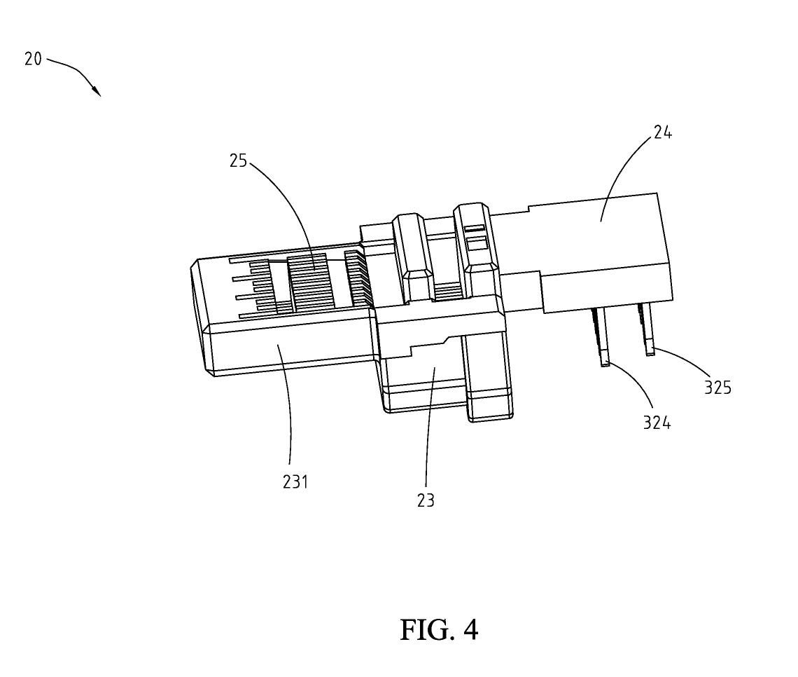

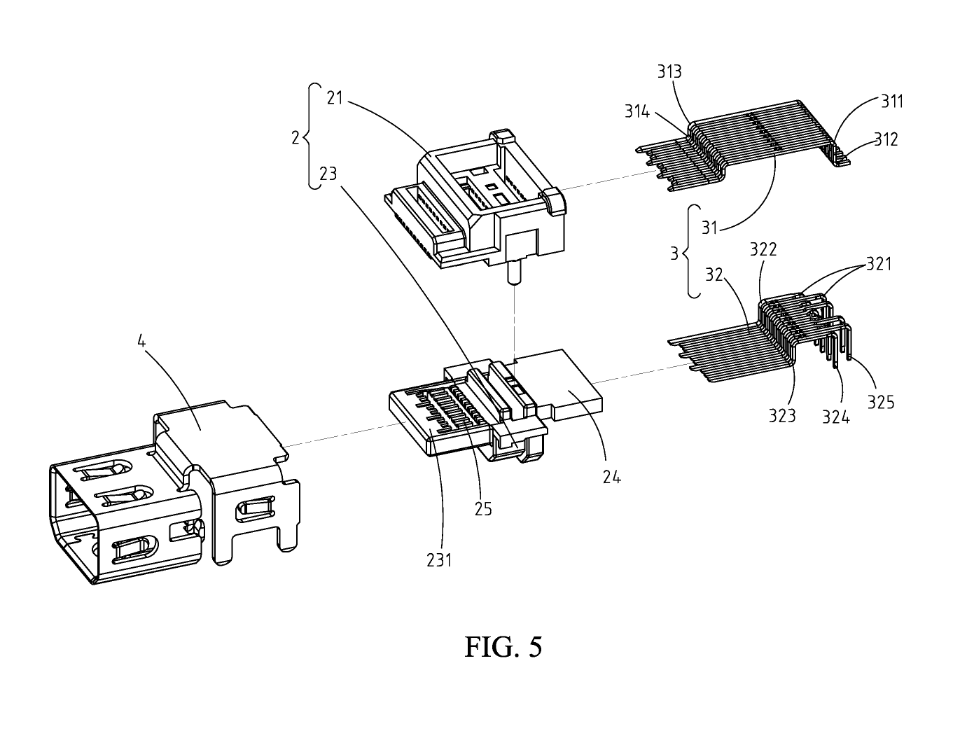

Please refer to FIG. 4 and FIG. 5, which are a perspective view of some components of a micro-connector socket 20 of a second embodiment of the disclosure and an exploded view of the micro-connector socket 20 of the second embodiment of the disclosure respectively. As shown in FIG. 4 and FIG. 5, the micro-connector socket 20 of this embodiment is approximately the same as that of the first embodiment, except that in the second embodiment the upper terminal 31 further includes a third upper bending portion 313 and a fourth upper bending portion 314, and the lower terminal 32 further includes a second lower bending portion 322 and a third lower bending portion 323.

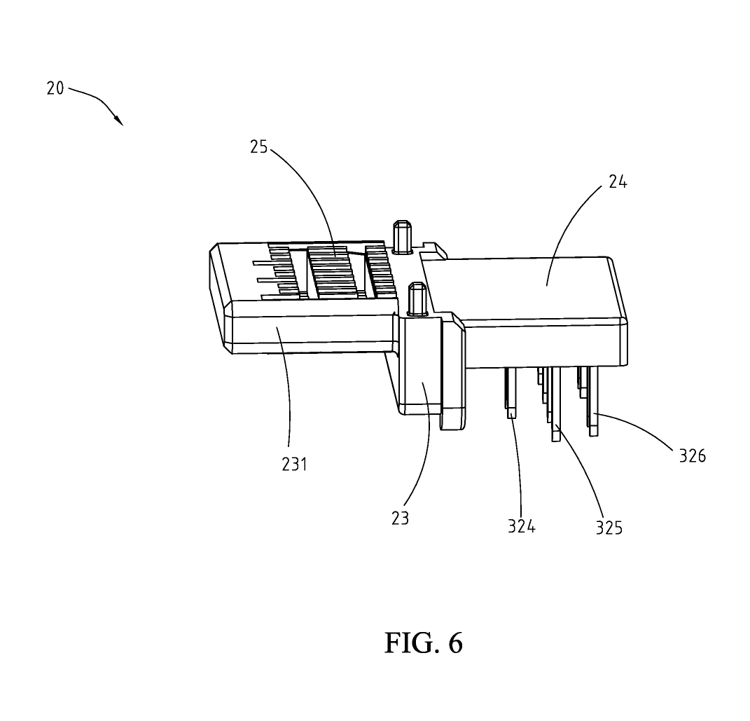

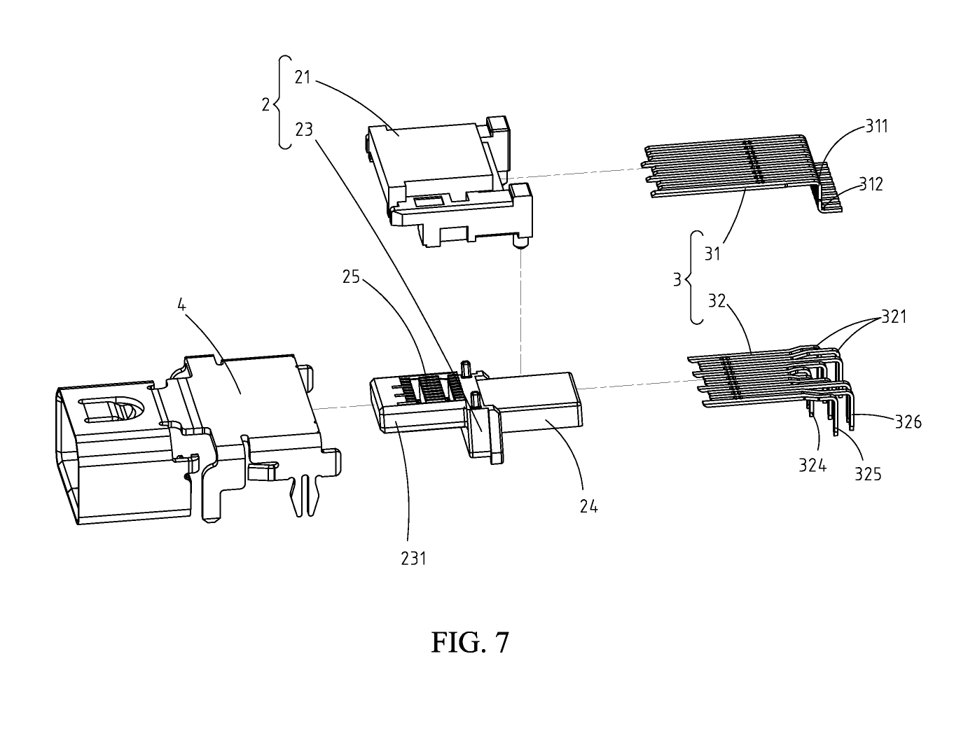

Please refer to FIG. 6 and FIG. 7, which are a perspective view of some components of a micro-connector socket 20 of a third embodiment of the disclosure and an exploded view of the micro-connector socket 20 of the third embodiment of the disclosure respectively. As shown in FIG. 6 and FIG. 7, the micro-connector socket 20 of this embodiment is approximately the same as that of the first embodiment, except that in the third embodiment, the lower terminal 32 further includes a third lower terminal 326.

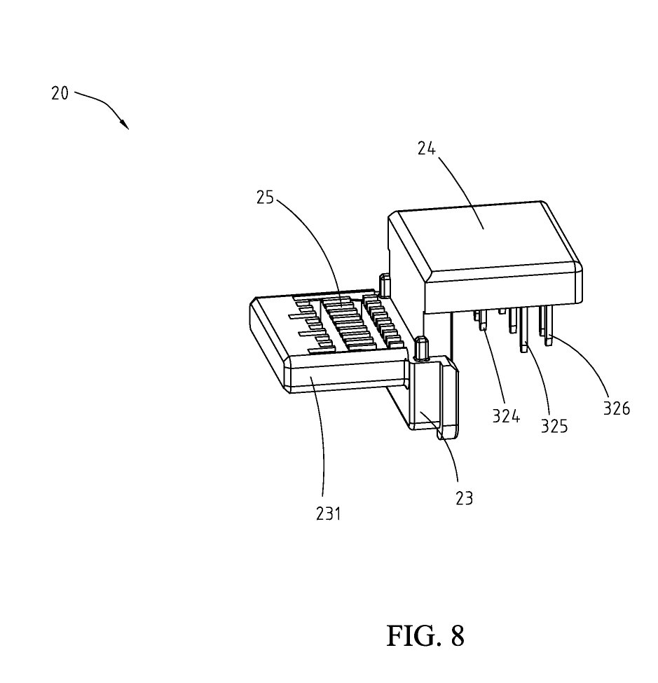

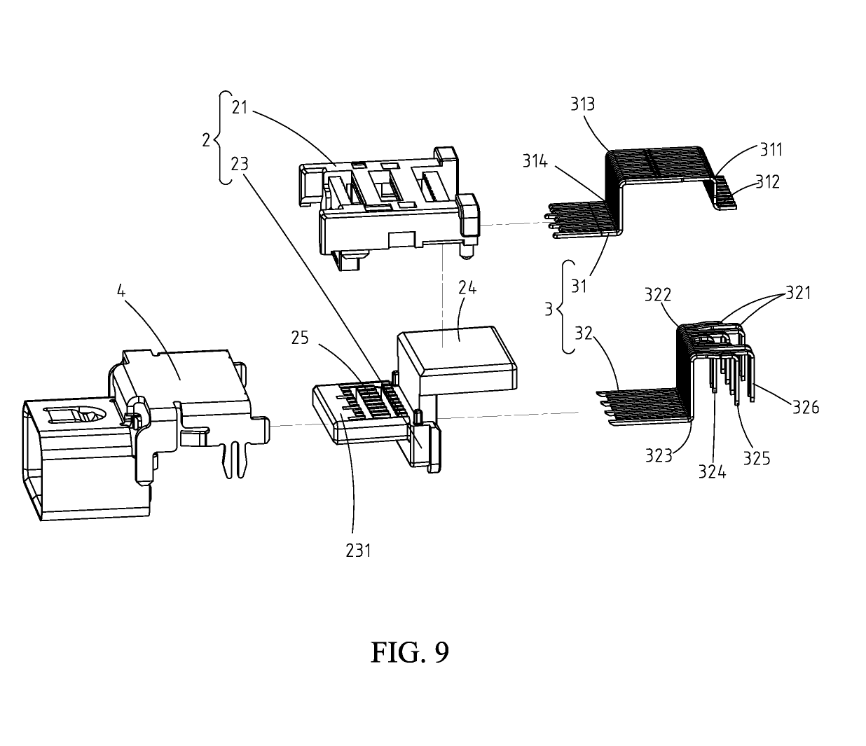

Please refer to FIG. 8 and FIG. 9, which are a perspective view of some components of a micro-connector socket 20 of a fourth embodiment of the disclosure and an exploded view of the micro-connector socket 20 of the fourth embodiment of the disclosure respectively. As shown in FIG. 8 and FIG. 9, the micro-connector socket 20 of this embodiment is approximately the same as that of the third embodiment, except that in the fourth embodiment, the upper terminal 31 further includes a third upper bending portion 313 and a fourth upper bending portion 314, and the lower terminal 32 further includes a second lower bending portion 322 and a third lower bending portion 323.

The disclosure has following advantages.

Firstly, the disclosure stabilizes the transmitting signals of the electronic device therewith, and the electronic characteristics of the disclosure meet the requirements.

Secondly, the disclosure reduces the difficulty of the manufacturing processes and the manufacturing costs.

Thirdly, the disclosure has a modular design so that the disclosure has high community between different electronic devices.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A micro-connector socket, capable of being connected with a predefined connector plug, comprising:
an insulating main body, comprising:
a base portion;
a positioning portion, formed by extending the base portion backwardly; and
a tongue plate, formed by extending the base portion forwardly, having a terminal groove passing through the base portion and the positioning portion;
a plurality of terminal, being inserted into the terminal groove of the insulating main body; and
a metal housing, enclosing out of the insulating main body;
wherein the terminals are positioned by the positioning portion, so that the terminals are in true positions.

2. The micro-connector socket according to claim 1, wherein the insulating main body comprises a main body connected with the base portion, such that the main body and the base are formed integrally as a whole or detachably assembled with each other.

3. The micro-connector socket according to claim 1, wherein the terminals comprises an upper terminal and a lower terminal.

4. The micro-connector socket according to claim 3, wherein the upper terminal comprises a first upper bending portion and a second upper bending portion.

5. The micro-connector socket according to claim 4, wherein the upper terminal further comprises a third upper bending portion and a fourth upper bending portion.

6. The micro-connector socket according to claim 3, wherein the lower terminal further comprises a first lower bending portion.

7. The micro-connector socket according to claim 6, wherein the lower terminal further comprises a second lower bending portion and a third lower bending portion.

8. The micro-connector socket according to claim 3, wherein the lower terminal comprises a first lower terminal and a second lower terminal.

9. The micro-connector socket according to claim 8, wherein the lower terminal further comprises a third lower terminal.
